(19) United States
(12) Patent Application Publication
(10) Pub. No.: US 2010/0329356 A1
(43) Pub. Date: Dec. 30, 2010

(54) Image Processing Apparatus and Associated Method

(75) Inventors: Mei-Ju Chen, Hsinchu Hsien (TW); Jen-Shi Wu, Hsinchu Hsien (TW)

Correspondence Address: EDELL, SHAPIRO & FINNAN, LLC, 1901 RESEARCH BOULEVARD, SUITE 400, ROCKVILLE, MD, 20850, US

(73) Assignee: MSTAR SEMICONDUCTOR, INC., Hsinchu Hsien (TW)

(21) Appl. No.: 12/783,699

(22) Filed: May 20, 2010

(30) Foreign Application Priority Data
Jun. 26, 2009 (TW) 098121607

(51) Int. Cl. H04N 9/77; H04N 7/12

(52) U.S. Cl. 375/240.25; 348/663; 375/E07.026; 348/E09.035

(57) ABSTRACT

An image processing apparatus includes an image decoding unit and an image adjusting unit. The image decoding unit decodes a data stream to generate a first image and a second image respectively having a first pixel and a second pixel at the same target position. The image adjusting unit generates a luminance motion parameter and a chrominance motion parameter according to initial luminance values and initial chrominance values of the first pixel and the second pixel, and generates an adjusted chrominance value of the first pixel by weighted averaging the initial chrominance values of the first pixel according to the luminance motion parameter and the chrominance motion parameter.

### CROSS REFERENCE TO RELATED PATENT APPLICATION

This patent application is based on Taiwan, R.O.C. patent application No. 098121607 filed on Jun. 26, 2009.

### FIELD OF THE INVENTION

The present invention relates to an image processing apparatus, and more particularly, to an image processing apparatus and an associated method that perform cross-color processing of an image frame according to a degree of motion or variation of the image frame.

### BACKGROUND OF THE INVENTION

In a conventional television (TV) system, a TV signal comprises a luminance component and a chrominance component. Upon receiving the TV signal, the TV system separates the luminance component and the chrominance component (i.e., a Y/C separation) via a filter. However, when a part of an image frame 110 in FIG. 1 comprises high frequency luminance in the spatial domain (i.e., the luminance varies very frequently in spatial domain), luminance and chrominance data of a partial TV signal cannot be accurately restored, e.g., the high frequency luminance components may be treated as chrominance components to result in rainbow-like chrominance on the image frame. The rainbow-like chrominance is also referred to as a cross-color phenomenon that causes defects on the image frame.

When cross-color occurs, for a pixel at a position on consecutive static frames, chrominance values of the pixel at the same position of two associated frames (e.g., two frames of a two-frame interval in a National Television System Committee (NTSC) system, or two frames of a four-frame interval in a Phase Alternation Line (PAL) system) are respectively C+ΔC and C−ΔC, where C is an ideal chrominance value of the pixel at the position, ΔC is a chrominance deviation caused by the high frequency luminance. Therefore, in order to overcome the issue of cross-color, an average chrominance value of the pixel at the same position of the two associated frames is calculated, and the calculated average chrominance value is regarded as the chrominance value of the pixel at the same position of the two associated frames. However, the foregoing method for overcoming the issue of cross-color is only suitable for consecutive static frames. More specifically, when a moving object contains high frequency luminance in spatial domain of an image frame, not only does the foregoing method not overcome the issue of cross-color, but a greater error in chrominance of the image frame may also result.

### SUMMARY OF THE INVENTION

Therefore, one object of the present invention is to provide an image processing apparatus and an associated method to compensate chrominance of an image frame according to a degree of motion or variation of the image frame, thereby solving the foregoing problem.

The present invention provides an image processing apparatus comprising an image decoding unit, and an image adjusting unit. The image adjusting unit comprises a luminance motion calculating module, a chrominance motion calculating module, and a chrominance adjusting module. The image decoding unit decodes a data stream to generate a plurality of images comprising a first image and a second image respectively comprising a first pixel and a second pixel at the same position. The luminance motion calculating module calculates a luminance motion parameter according to initial luminance values of the first pixel and the second pixel. The chrominance motion calculating module calculates a chrominance motion parameter according to initial chrominance values of the first pixel and the second pixel. The chrominance adjusting module generates an adjusted chrominance value of the first pixel by weight averaging the initial chrominance values of the first pixel and the second pixel according to the luminance motion parameter and the chrominance motion parameter.

The present invention further provides an image processing apparatus for processing a plurality of images comprising a first image and a second image respectively having a first pixel and a second pixel at the same position. The image processing apparatus comprises a chrominance averaging module, a luminance motion calculating module, a chrominance motion calculating module and a chrominance adjusting module. The chrominance averaging module averages two initial chrominance values of the first pixel and the second pixel to generate an average chrominance value of the first pixel. The luminance motion parameter calculating module calculates a luminance motion parameter according to two initial luminance values of the first pixel and the second pixel. The chrominance motion calculating module calculates a chrominance motion parameter according to the initial chrominance values of the first pixel and the second pixel. The chrominance adjusting module generates an adjusted chrominance value of the first pixel by weighted averaging the average chrominance value of the first pixel and the initial chrominance value of the first pixel according to the luminance motion parameter and the chrominance motion parameter.

The present invention further provides an image processing method comprising: decoding a data stream to generate a plurality of images comprising a first image and a second image respectively having a first pixel and a second pixel at the same target position; calculating a luminance motion parameter according to an initial luminance value of the first pixel and the second pixel; calculating a chrominance motion parameter according to an initial chrominance value of the first pixel and an initial chrominance value of the second pixel; and according to the luminance motion parameter and the chrominance motion parameter, by weighted averaging the initial chrominance value of the first pixel and the initial chrominance value of the second pixel generating an adjusted chrominance value of the first pixel.

According to an image processing apparatus and an image processing method provided by the invention, an adjusted chrominance value of the first pixel is determined according to a luminance motion parameter and a chrominance motion parameter, i.e., compensation of an image is determined according to a degree of motion or variation of the image, so as to prevent the problem of cross-color previously caused by compensation.

### BRIEF DESCRIPTION OF THE DRAWINGS

FIG. 1 is a schematic diagram of high frequency luminance in spatial domain of a partial image frame.

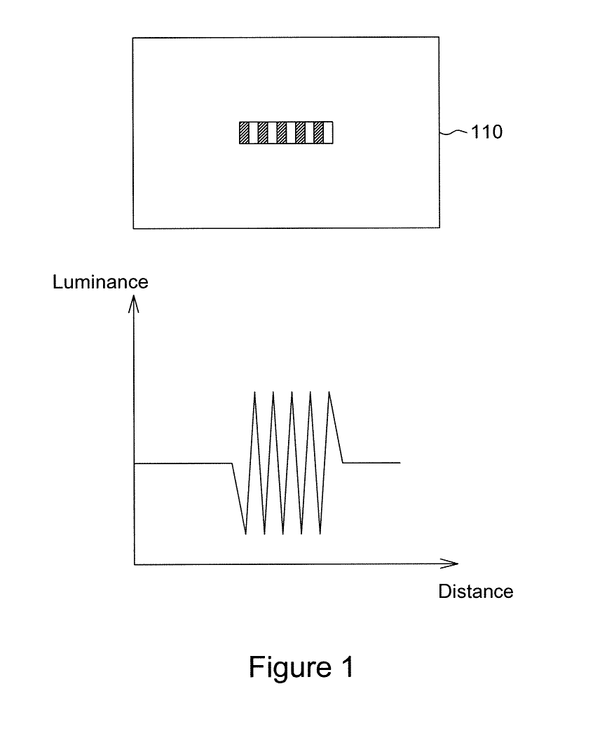

FIG. 2A is a schematic diagram of an image processing apparatus in accordance with a first embodiment of the present invention.

FIG. 2B is a schematic diagram of an image adjusting module shown in FIG. 2A.

FIG. 3 is a flow chart of an image processing method performed by the image processing apparatus in FIG. 2A and FIG. 2B on a data stream.

FIG. 4 is a schematic diagram of a plurality of fields.

FIG. 5 is a schematic diagram for illustrating a cross-color edge value and a real-color edge value of an image frame.

FIG. 6 is a diagram of a curve showing characteristics of a motion parameter value and a weight.

FIG. 7 is a schematic diagram of an image processing apparatus in accordance with a second embodiment of the present invention.

### DETAILED DESCRIPTION OF THE PREFERRED EMBODIMENT

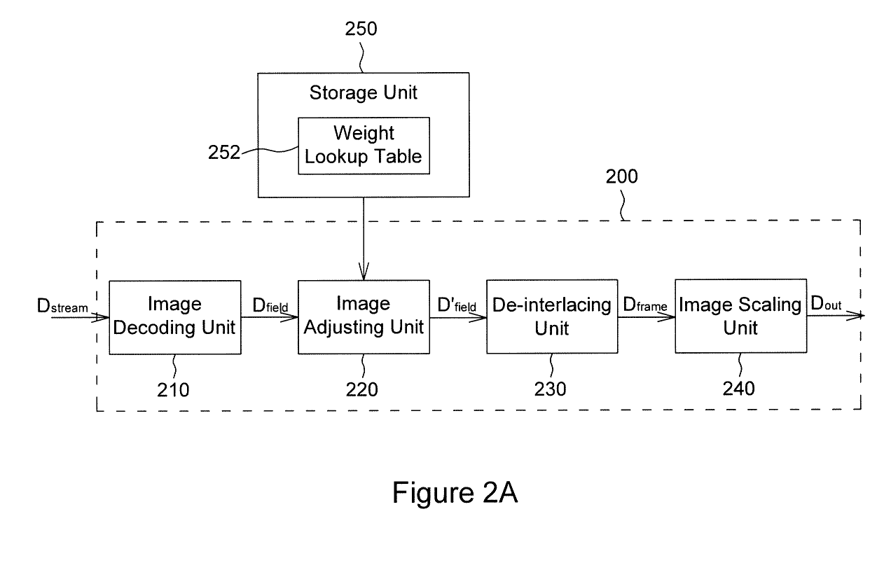

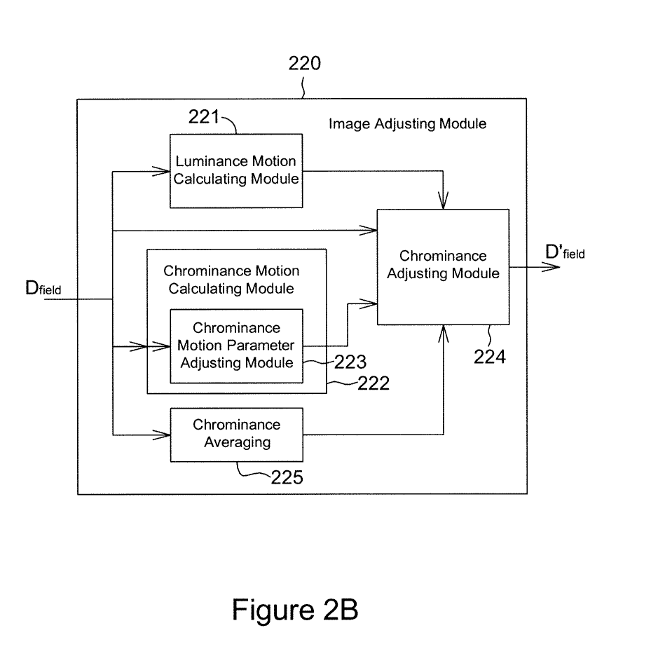

FIG. 2A and FIG. 2B show schematic diagrams of an image processing apparatus 200 in accordance with a first embodiment of the present invention. The image processing apparatus 200 comprises an image decoding unit 210, an image adjusting unit 220, a de-interlacing unit 230, and an image scaling unit 240. The image adjusting unit 220, coupled to a storage unit 250, comprises a luminance motion calculating module 221, a chrominance motion calculating module 222, a chrominance adjusting module 224, and a chrominance averaging module 225. The chrominance motion calculating module 222 comprises a chrominance motion parameter adjusting module 223. It is to be noted that, the chrominance averaging module 225 is an optional component, and is not used in all embodiments of the present invention. The storage unit 250 comprises a weight lookup table 252. In addition, the image processing apparatus 200 could be realized by hardware or software.

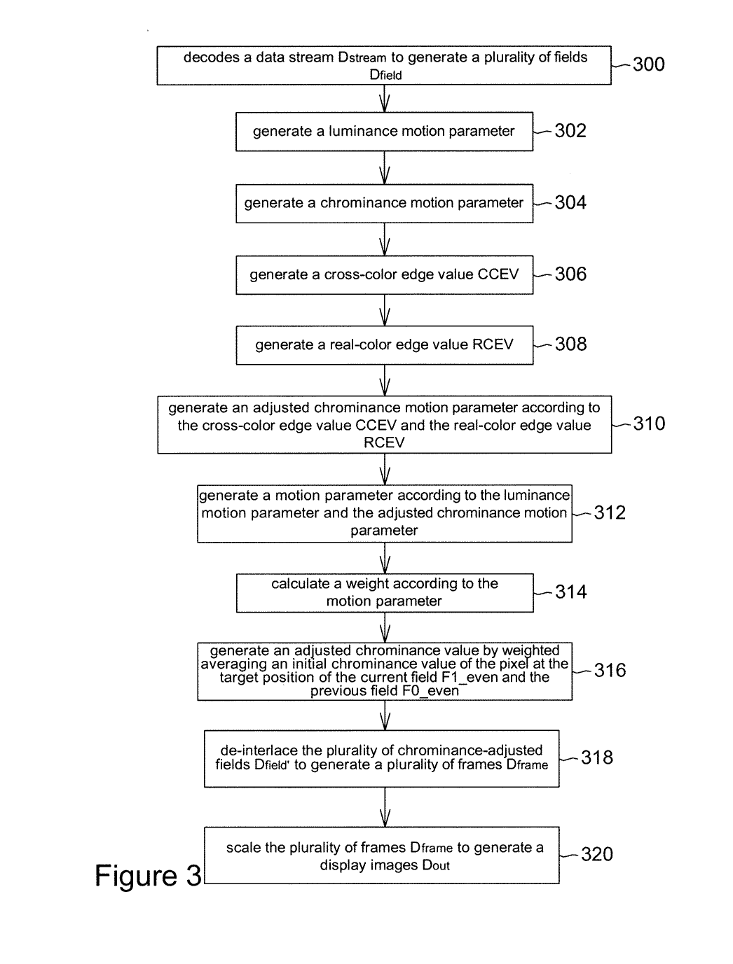

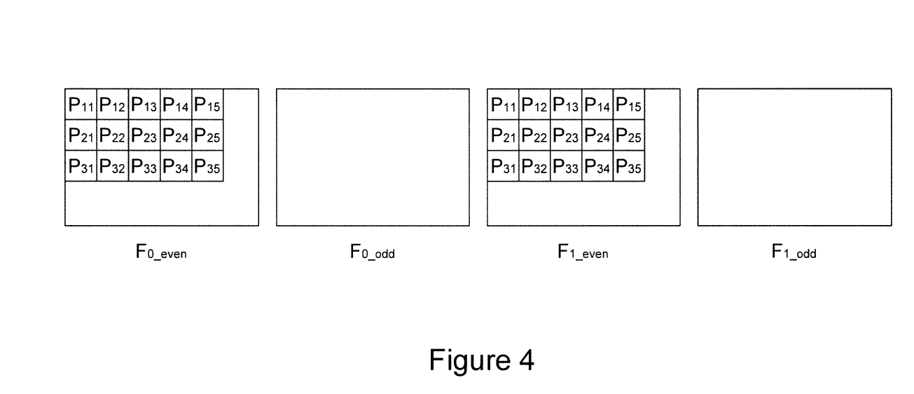

The description below is given with reference to FIG. 2A, FIG. 2B and FIG. 3. FIG. 3 is a flow chart of performing image processing by the image processing apparatus 200 on a data stream Dₛₜᵣₑₐₘ. In Step 300, the image decoding unit 210 decodes the data stream Dₛₜᵣₑₐₘ to generate a plurality of fields D_{field} in FIG. 4. The fields D_{field} comprise a previous even field F₀_{_{—}}ₑᵥₑₙ, a previous odd field F₀_{_{—}}_{odd}, a current even field F₁_{_{—}}ₑᵥₑₙ, and a current odd field F₁_{_{—}}_{odd}. Each of the fields F₀_{_{—}}ₑᵥₑₙ, F₀_{_{—}}_{odd}, F₁_{_{—}}ₑᵥₑₙ and F₁_{_{—}}_{odd} comprises an initial luminance value and an initial chrominance value of each pixel (i.e., P₁₁, P₁₂, P₁₃ . . . ). For example, the initial luminance value is a directly decoded original luminance value or is a noise-processed luminance value; likewise, the initial chrominance value is a directly decoded original chrominance value or is a noise-processed chrominance value. In addition, the fields F₀_{_{—}}ₑᵥₑₙ and F₁_{_{—}}ₑᵥₑₙ have a pixel at a same position on an image, i.e., positions of the pixels P₁₁, P₁₂, P₁₃, . . . , of the fields F₀_{_{—}}ₑᵥₑₙ and F₁_{_{—}}ₑᵥₑₙ are the same on the image.

In Step 302, for a pixel at a target position of the current field F₁_{_{—}}ₑᵥₑₙ, the luminance motion calculating module 221 calculates a luminance difference between luminance values of the pixel at the target position of the current field F₁_{_{—}}ₑᵥₑₙ and the previous field F₀_{_{—}}ₑᵥₑₙ, and generates a luminance motion parameter Ymv according to at least the luminance difference. Taking the pixel P₁₃ in the current field F₁_{_{—}}ₑᵥₑₙ as an example, i.e., supposing that the pixel P₁₃ is the pixel at the target position, the luminance motion parameter Ymvp₁₃ of the pixel P₁₃ is calculated using one of the formulae below.

Ymv_{P13}=|Y₁₃_{_{—}}₁−Y₁₃_{_{—}}₀| (1)

Ymv_{P13}=a₁*|Y₁₁_{_{—}}₁−Y₁₁_{_{—}}₀|+a₂*|Y₁₂_{_{—}}₁−Y₁₂_{_{—}}₀|+a₃*|Y₁₃_{_{—}}₁−Y₁₃_{_{—}}₀|+a₄*|Y₁₄_{_{—}}₁−Y₁₄_{_{—}}₀|+a₅*|Y₁₅_{_{—}}₁−Y₁₅_{_{—}}₀| (2)

Wherein, Y₁₁_{_{—}}₁, Y₁₂_{_{—}}₁, Y₁₃_{_{—}}₁, Y₁₄_{_{—}}₁ and Y₁₅_{_{—}}₁ are respectively initial luminance values of the pixels P₁₁, P₁₂, P₁₃, P₁₄ and P₁₅ in the current field F₁_{_{—}}ₑᵥₑₙ, Y₁₁_{_{—}}₀, Y₁₂_{_{—}}₀, Y₁₃_{_{—}}₀, Y₁₄_{_{—}}₀ and Y₁₅_{_{—}}₀ are respectively initial luminance values of the pixels P₁₁, P₁₂, P₁₃, P₁₄ and P₁₅ in the previous field F₀_{_{—}}ₑᵥₑₙ, and a₁ to a₅ are constants (e.g., a₁, a₂, a₃, a₄ and a₅ respectively equal to (⅛, ¼, ¼, ¼, ⅛)).

It is to be noted that, the foregoing formulae for calculating the luminance motion parameter Ymvp₁₃ are disclosed for illustration purposes, and other approaches may also be applied to calculate the luminance motion parameter Ymvp₁₃, e.g., a luminance motion parameter is calculated according to a luminance difference between two neighboring pixels in a two-dimensional spatial domain. Taking a pixel P₂₂ in the current field F₁_{_{—}}ₑᵥₑₙ as an example, a luminance motion parameter Ymvp₂₂ of the pixel P₂₂ is calculated as:

Ymv_{P22}=a₁₁*|Y₁₁_{_{—}}₁−Y₁₁_{_{—}}₀|+a₁₂*|Y₁₂_{_{—}}₁−Y₁₂_{_{—}}₀|+a₁₃*|Y₁₃_{_{—}}₁−Y₁₃_{_{—}}₀|+a₂₁*|Y₂₁_{_{—}}₁−Y₂₁_{_{—}}₀|+a₂₂*|Y₂₂_{_{—}}₁−Y₂₂_{_{—}}₀|+a₂₃*|Y₂₃_{_{—}}₁−Y₂₃_{_{—}}₀|+a₃₁*|Y₃₁_{_{—}}₁−Y₃₁_{_{—}}₀|+a₃₂*|Y₃₂_{_{—}}₁−Y₃₂_{_{—}}₀|+a₃₃*|Y₃₃_{_{—}}₁−Y₃₃_{_{—}}₀| (3)

Wherein, Y₁₁_{_{—}}₁ to Y₃₃_{_{—}}₁ are respectively initial chrominance values of pixels P₁₁ to P₃₃ in the current field F₁_{_{—}}ₑᵥₑₙ, Y₁₁_{_{—}}₀ to Y₃₃_{_{—}}₀ are respectively initial luminance values of the pixels P₁₁ to P₃₃, and a₁₁ to a₃₃ are constants. It is to be noted that a luminance motion parameter of a pixel P_{xy} is determined according to a luminance difference between luminance values of the pixel P_{xy} at the current field F₁_{_{—}}ₑᵥₑₙ and at the previous field F₀_{_{—}}ₑᵥₑₙ. In practice, a designer can obtain the luminance motion parameter of the pixel P_{xy} via other calculation formulae according to different design considerations.

After that, in Step 304, for the pixel at the target position of the current field F₁_{_{—}}ₑᵥₑₙ, the chrominance motion calculating module 222 calculates a chrominance difference between chrominance values of the pixel at the target position of the current field F₁_{_{—}}ₑᵥₑₙ and the previous field F₀_{_{—}}ₑᵥₑₙ, and generates a chrominance motion parameter Cmv according to at least the luminance difference. Taking the pixel P₁₃ in the current field F₁_{_{—}}ₑᵥₑₙ as an example, i.e., supposing that the pixel P₁₃ is the pixel at the target position, the luminance motion parameter Cmvp₁₃ of the pixel P₁₃ is calculated using one of the formulae below.

Cmv_{P13}=|C₁₃_{_{—}}₁−C₁₃_{_{—}}₀ (4)

Cmv_{P13}a₁*|C₁₁_{_{—}}₁−C₁₁_{_{—}}₀|+a₂*|C₁₂_{_{—}}₁−C₁₂_{_{—}}₀|+a₃*|C₁₃_{_{—}}₁−C₁₃_{_{—}}₀|+a₄*|C₁₄_{_{—}}₁−C₁₄_{_{—}}₀|+a₅*|C₁₅_{_{—}}₁−C₁₅_{_{—}}₁| (5)

Wherein, C₁₁_{_{—}}₁, C₁₂_{_{—}}₁, C₁₃_{_{—}}₁, C₁₄_{_{—}}₁ and C₁₅_{_{—}}₁ are respectively initial chrominance values of the pixels P₁₁, P₁₂, P₁₃, P₁₄ and P₁₅ in the current field F₁_{_{—}}ₑᵥₑₙ, C₁₁_{_{—}}₀, C₁₂_{_{—}}₀, C₁₃_{_{—}}₀, C₁₄_{_{—}}₀ and C₁₅_{_{—}}₀ are respectively initial chrominance values of the pixels P₁₁, P₁₂, P₁₃, P₁₄ and P₁₅ in the previous field F₀_{_{—}}ₑᵥₑₙ, and a₁ to a₅ are constants. It is to be noted that, either the chrominance component U (or Cb) and or the chrominance component V (or Cr), or both of the chrominance components U (or Cb) and V (or Cr) can be regarded as the initial chrominance values for calculating the foregoing chrominance motion parameter. In addition, the chrominance motion parameter Cmv is calculated according to a chrominance difference between two neighboring pixels in a two-dimensional spatial domain, and the approach for calculating the chrominance motion parameter Cmv are similar to that for calculating the luminance motion parameter Ymv, such that details thereof shall not be described for brevity. Provided that the chrominance motion parameter of a pixel P_{xy} is determined according to a chrominance difference between chrominance values of the pixel P_{xy} at the current field F₁_{_{—}}ₑᵥₑₙ and the previous field F₀_{_{—}}ₑᵥₑₙ, a designer can obtain the chrominance motion parameter of the pixel P_{xy} via other calculation formulae according to different design considerations.

An objective of calculating the luminance motion parameter Ymv and the chrominance motion parameter Cmv is to represent a degree of motion of an object on an image (i.e., the current field F₁_{_{—}}ₑᵥₑₙ). More specifically, when one of the luminance motion parameter Ymv and the chrominance motion parameter Cmv of a pixel is large, it means that an object corresponding to the pixel on an image is in motion or a variation exists. When both of the luminance motion parameter Ymv and the chrominance motion parameter Cmv of the pixel are small, it means that an object corresponding to the pixel on the image is substantially static.

However, when cross-color accompanies static image, for a pixel at a target position within an area in which cross-color occurs, chrominance values of the pixel at the target position of two corresponding successive images (i.e. the current field F₁_{_{—}}ₑᵥₑₙ and the previous field F₀_{_{—}}ₑᵥₑₙ) are respectively C+ΔC and C−ΔC, where C is an ideal chrominance value of the pixel at the target pixel, and ΔC is a chrominance deviation caused by high frequency luminance effect. It is to be noted that, the initial chrominance values of the fields D_{field} decoded by the image decoding unit 210 are already undesirably affected by cross-color, i.e., the initial chrominance values of the fields D_{field} are in fact C+ΔC and C−ΔC. Therefore, since the image is static, a chrominance motion parameter Cmv is calculated as 2*ΔC (Cmv=|(C+ΔC)−(C−ΔC|) using the foregoing Formula 1 for calculating the chrominance motion parameter Cmv; however, in theory, the chrominance motion parameter Cmv should be zero since the chrominance values of the pixel at the target position of two corresponding successive images are the same for that the images are static. Accordingly, the static images are mistakenly determined as motion images to thereby create errors in the subsequent image processing.

In order to solve the foregoing problem that a chrominance motion parameter Cmv fails to truly represent a degree of motion of an image, in Step 306, the chrominance parameter adjusting module 223 of the chrominance motion calculating module 222 generates a cross-color edge value CCEV according to the initial chrominance value of the pixel at the target position and an initial chrominance value of at least one pixel neighboring to the pixel at the target pixel. The cross-color edge value CCEV is for solving the problem that a chrominance motion parameter Cmv fails to truly represent a degree of motion of an image frame due to cross-color. Taking the pixel P₁₃ in the current field F₁_{_{—}}ₑᵥₑₙ as an example, when the image frame is in a conventional YUV444 format, a cross-color edge value CCEVp₁₃ of the pixel P₁₃ is calculated as:

CCEV_{P13}=b₁*|C₁₂_{_{—}}₁−C₁₁_{_{—}}₁|+b₂*|C₁₃_{_{—}}₁−C₁₂_{_{—}}₁|+b₃*|C₁₄_{_{—}}₁−C₁₃_{_{—}}₁|+b₄*|C₁₅_{_{—}}₁−C₁₄_{_{—}}₁| (6)

Wherein, C₁₁_{_{—}}₁, C₁₂_{_{—}}₁, C₁₃_{_{—}}₁, C₁₄_{_{—}}₁ and C₁₅_{_{—}}₁ are respectively initial chrominance values of the pixels P₁₁, P₁₂, P₁₃, P₁₄ and P₁₅ in the current field F₁_{_{—}}ₑᵥₑₙ, and b₁ to b₅ are constants. In addition, either the chrominance component U or chrominance component V, or both of the chrominance components U and V can be regarded as the initial chrominance values for calculating the foregoing cross-color edge value CCEV. When the image frame is in a conventional YUV422 format, the cross-color edge value CCEVp₁₃ of the pixel P₁₃ is calculated as:

CCEV_{P13}=c₁*|C₁₃_{_{—}}₁−C₁₁_{_{—}}₁|+c₂*|C₁₄_{_{—}}₁−C₁₂_{_{—}}₁|+c₃*|C₁₅_{_{—}}₁−C₁₃_{_{—}}₁| (7)

Wherein, C₁, C₂ and C₃ are constants.

It is to be noted that, other calculation approaches can be applied to calculate a cross-color edge value CCEV, provided that a cross-color edge value CCEV of a pixel P_{xy} is determined according to a an initial chrominance value of the pixel P_{xy} and an initial chrominance value of at least one pixel neighboring to the pixel P_{xy}, and a designer can obtain the cross-color edge value CCEV of the pixel P_{xy} using other formulae according to the YUV format (e.g., 444 or 422) or different design considerations.

A reason for adjusting a chrominance motion parameter Cmv with a cross-color edge value CCEV is described below. Under two situations, the chrominance motion parameter Cmv may be rather large—a first situation is that an object having a significant color difference from a background of an image frame moves (e.g., a red ball rolls across green lawns) and a second situation that cross-color occurs in a static image frame. Under the first situation, the chrominance motion parameter Cmv does truly reflect that there is a moving object in the image; however, under the second situation, the chrominance motion parameter Cmv may mistakenly determine that there is a moving object in the image (i.e., the chrominance motion parameter Cmv calculated by the chrominance motion calculating module 222 is large (e.g., 2*ΔC) when in fact the image frame is static.) Therefore, the cross-color edge value CCEV is a parameter indicating whether cross-color occurs in an image, whereas the significance for calculating the cross-color edge value CCEV is to be described below. Generally speaking, when cross-color occurs in an area of an image, the chrominance of the area in spatial domain may drastically change, which is referred to as high frequency chrominance (i.e., the variance of chrominance in spatial domain is high). However, in a normal image frame, the spatial changes in chrominance are mild (i.e., the spatial frequency of chrominance space is relatively low). Therefore, when a cross-color edge value CCEV at a target position is large, it means that the target position is within an area in which cross-color occurs; when the cross-color edge value CCEV at the target position is small, it means that the area comprising the target position is free of cross-color.

Therefore, a chrominance motion parameter Cmv may be adjusted via a cross-color edge value CCEV, such that an adjusted chrominance motion parameter C′mv can accurately reflect a degree of motion of a pixel at a target position of an image. Taking the pixel P₁₃ of the current field F₁_{_{—}}ₑᵥₑₙ as an example, the adjusted chrominance motion parameter C′mv is calculated as:

C′mv_{P13}=Cmv_{P13}−CCEV_{P13} (8)

Wherein, Cmvp₁₃ is a chrominance motion parameter of the pixel P₁₃ calculated in Step 304, and CCEVp₁₃ is a cross-color edge value CCEV of the pixel P₁₃ calculated in Step 306.

As mentioned above, when an image frame is static, the chrominance motion parameter Cmv and the cross-color edge value CCEV may be large. The adjusted chrominance motion parameter C′mv generated from subtracting the chrominance motion parameter Cmv from the cross-color edge value CCEV using the foregoing Formula (8) may be small and can truly reflect the static image.

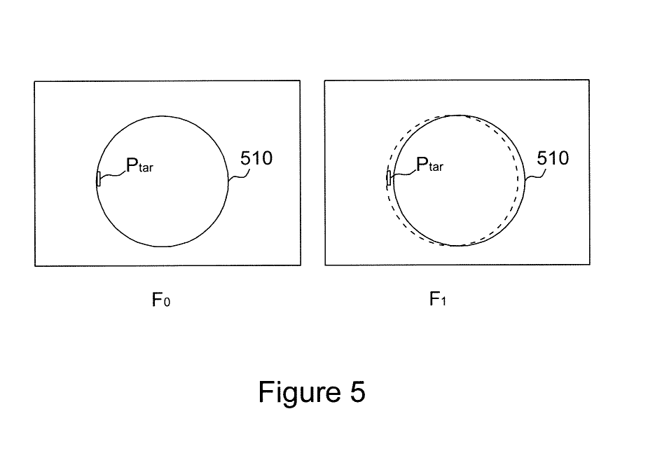

Therefore, the implementation of the cross-color edge value CCEV is capable of adjusting the chrominance motion parameter Cmv to avoid cross-color from being considered as a moving object in the image. However, under a special situation below, adjustment performed by adding the cross-color edge value CCEV still cannot solve the issue of cross-color occurring at motion edges of the object. Referring to FIG. 5 showing two successive frames F₀ and F₁, the frame F₀ is a previous image comprising the fields F₀_{_{—}}ₑᵥₑₙ and F₀_{_{—}}_{dd} in FIG. 4, and the frame F₁ is a current image comprising the fields F₁_{_{—}}ₑᵥₑₙ and F₁_{_{—}}_{dd} in FIG. 4. The frames F₀ and F₁ display that a red ball 510 rolls across a green lawn, i.e., backgrounds of the frames F₀ and F₁ are green. Accordingly, an adjusted chrominance motion parameter C′mv of a pixel Pₜₐᵣ at a target position of the frame F₁ is underestimated (e.g., the pixel Pₜₐᵣ at a same position of the frame F₀ and the frame F₁ in FIG. 5). More specifically, since the pixel Pₜₐᵣ at the target position is located at the green background (corresponding to edges of the red ball 510 in the previous frame F₀) of the frame F₁, a chrominance motion parameter Cmv of the pixel Pₜₐᵣ is supposedly large (i.e., the green part of the image frame F₁ and the red part of the image frame F₀). However, the chrominance motion parameter Cmv of the pixel Pₜₐᵣ calculated according to Formula (5) is smaller than an actual value since an average chrominance value of neighboring pixels is added in Formula (5). Therefore, the adjusted chrominance motion parameter C′mv calculated according to Formula (8) is smaller than an actual value, such that chrominance of the pixel Pₜₐᵣ cannot be accurately adjusted.

Therefore, in order to solve the abovementioned problem, in Step 308, the chrominance motion parameter adjusting module 223 generates a real-color edge value RCEV according to at least a plurality of initial chrominance values of a plurality of neighboring pixels of the pixel at the target pixel at the field F₀_{_{—}}ₑᵥₑₙ and a plurality of initial chrominance values of the plurality of neighboring pixels of the pixel at the target pixel at the field F₁_{_{—}}ₑᵥₑₙ, and further adjusts the cross-color edge value CCEV with the real-color edge value RCEV. Taking the pixel P₁₃ at the current fields F₁_{_{—}}ₑᵥₑₙ as an example, a real-color edge value RCEV of the pixel P₁₃ is calculated as:

C′₁₁=(C₁₁_{_{—}}₁+C₁₁_{_{—}}₀)/2;

C′₁₂=(C₁₂_{_{—}}₁+C₁₂_{_{—}}₀)/2;

C′₁₃=(C₁₃_{_{—}}₁+C₁₃_{_{—}}₀)/2;

C′₁₄=(C₁₄_{_{—}}₁+C₁₄_{_{—}}₀)/2;

C′₁₅=(C₁₅_{_{—}}₁+C₁₅_{_{—}}₀)/2;

RCEV_{P13}h₁*|C′₁₂−C′₁₁|+h₂*|C′₁₃−C′₁₂|+h₃*|C′₁₄−C′₁₃|+h₄*|C′₁₅−C′₁₄| (9)

Wherein, C₁₁_{_{—}}₁ to C₁₅_{_{—}}₁ are respectively chrominance values of the pixels P₁₁ to P₁₅ at the field F₁_{_{—}}ₑᵥₑₙ, C₁₁_{_{—}}₀ to C₁₅_{_{—}}₀ are respectively chrominance values of the pixels P₁₁ to P₁₅ at the field F₀_{_{—}}ₑᵥₑₙ, and h₁ to h₄ are constants. In addition, either the chrominance component U or the chrominance component V, or both of the chrominance components U and V can be regarded as the initial chrominance values for calculating the real-color edge value RCEV. Provided that the real-color edge value RCEV of the pixel P_{xy} is determined according to a chrominance difference between chrominance values of the pixel P_{xy} at the current field F₁_{_{—}}ₑᵥₑₙ and the previous field F₀_{_{—}}ₑᵥₑₙ, a designer can obtain the real-color edge value RCEV of the pixel P_{xy} using different formulae according to other design considerations.

When the calculated real-color edge value RCEV of the pixel P_{xy} is large, it means that the pixel P_{xy} is at the edge of the moving object in FIG. 5; when the calculated real-color edge value RCEV of the pixel P_{xy} is small, it means that the pixel P_{xy} may be within an area having a small chrominance variation.

In Step 310, the chrominance motion parameter Cmv may be adjusted via the cross-color edge value CCEV and the real-color edge value RCEV, so that the adjusted chrominance motion parameter C′mv can truly represent a degree of motion of the pixel at the target position of the image frame. Taking the pixel P₁₃ at the current field F₁_{_{—}}ₑᵥₑₙ as an example, an adjusted chrominance motion parameter C′mvp₁₃ is calculated as:

C′mv_{P13}=Cmv_{P13}−CCEV_{P13}+RCEV_{P13} (10)

Wherein, Cmvp₁₃ is the chrominance motion parameter of the pixel P₁₃, calculated in Step 304, CCEVp₁₃ is the cross-color edge value of the pixel P₁₃ calculated in Step 306, and RCEVp₁₃ is the real-color edge value of the pixel P₁₃ calculated in Step 308.

After that, in Step 312, the chrominance adjusting module 224 generates a motion parameter MV according to the luminance motion parameter Ymv and the adjusted chrominance motion parameter C′mv. Taking the pixel P₁₃ at the current field F₁_{_{—}}ₑᵥₑₙ as an example, an motion parameter MVp₁₃ is calculated as (but not limited to):

MV_{P13}=Max{Ymv_{P13},C′mv_{P13}} (11)

MV_{P13}=d₁*Ymv_{P13}+d₂*C′mv_{P13} (12)

Wherein, Max { } is a maximum operator, Ymvp₁₃ is a luminance motion parameter of the pixel P13, C′mvp₁₃ is an adjusted chrominance motion parameter of the pixel P₁₃, and d₁ and d₂ are constants.

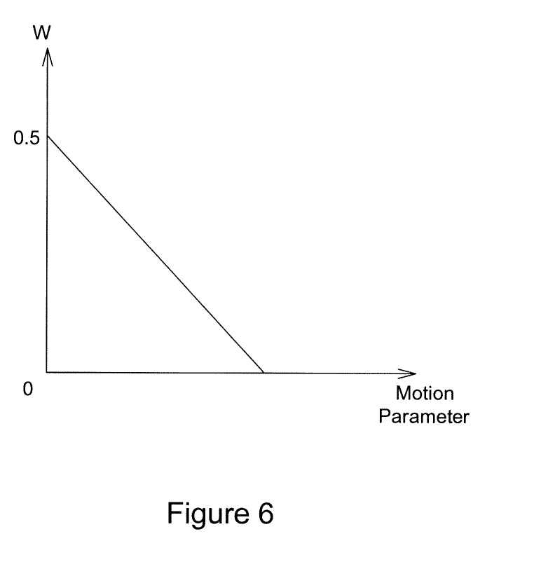

In Step 314, the chrominance module 224 calculates a weight W according to the motion parameter MV, and the weight W is determined according to the characteristic curve in FIG. 6 or the weight lookup table 252 stored in the storage unit 250 in FIG. 2A.

In Step 316, the chrominance adjusting module 224 by weighted averaging an initial chrominance value C of the pixel at the target position of the current field F₁_{_{—}}ₑᵥₑₙ and an initial chrominance value of the pixel at the target position of the previous field F₀_{_{—}}ₑᵥₑₙ to generate an adjusted chrominance value C′. Taking the pixel P₁₃ at the current field F₁_{_{—}}ₑᵥₑₙ as an example, an adjusted chrominance value C′₁₃_{_{—}}₁ is calculated as:

C′₁₃_{_{—}}₁=W*C₁₃_{_{—}}₀+(1−W)*C₁₃_{_{—}}₁ (13)

Wherein, C₁₃_{_{—}}₀ is an initial chrominance value of the pixel P₁₃ at the previous field F₀_{_{—}}ₑᵥₑₙ, and C₁₃_{_{—}}₁ is an initial chrominance value of the pixel P₁₃ at the current field F₁_{_{—}}ₑᵥₑₙ.

Inferred from Step 314 and Step 316, when an object in an image moves (or the image varies), a motion parameter MV of the pixel corresponding to the object is large, and the weight W calculated in Step 314 is accordingly small. Taking the P₁₃ at the current field F₁_{_{—}}ₑᵥₑₙ as an example, supposing that the weight W is 0.1, an adjusted chrominance value C′₁₃ of the pixel P₁₃ is calculated as:

C′₁₃_{_{—}}₁=0.1*C₁₃_{_{—}}₀+0.9*C₁₃_{_{—}}₁ (14)

Accordingly, the adjusted chrominance value C′₁₃_{_{—}}₁ approximates the initial chrominance value C₁₃_{_{—}}₁, i.e, only a little cross-color compensation is performed on the pixel P₁₃. When the image frame is static, the motion parameter MV of the pixel is equal to zero (or smaller than zero). Therefore, the weight W calculated in Step 314 is equal to 0.5. Taking the P₁₃ at the current field F₁_{_{—}}ₑᵥₑₙ as an example, the adjusted chrominance value C′₁₃ is calculated as:

C′₁₃_{_{—}}₁=0.5*C₁₃_{_{—}}₀+0.5*C₁₃_{_{—}}₁ (15)

That is, complete cross-color compensation is performed on the pixel P₁₃.

In another embodiment of the present invention, the chrominance averaging module 225 averages the initial chrominance value C of the pixel at the target position of the current field F₁_{_{—}}ₑᵥₑₙ and the initial chrominance value of the pixel at the target position of the previous field F₀_{_{—}}ₑᵥₑₙ to generate an average chrominance value C″ of the pixel at the target pixel of the current field F₁_{_{—}}ₑᵥₑₙ. In Step 314 to Step 316, a weight W₁ is calculated according to the motion parameter MV and an adjusted chrominance value C′ is calculated according to W₁ by weighted averaging the initial chrominance value C of the pixel at the target position of the current field F₁_{_{—}}ₑᵥₑₙ and the average chrominance value C″ of the pixel at the target pixel of the current field F₁_{_{—}}ₑᵥₑₙ. Taking the P₁₃ at the current field F₁_{_{—}}ₑᵥₑₙ as an example, an average chrominance value C″₁₃_{_{—}}₁ and an adjusted chrominance value C′₁₃ are calculated as:

C″₁₃_{_{—}}₁=0.5*C₁₃_{_{—}}₀+0.5*C₁₃_{_{—}}₁; and

C′₁₃_{_{—}}₁=W₁*C″₁₃_{_{—}}₁+(1″W₁)*C₁₃_{_{—}}₁.

Wherein, a relationship between the weight W₁ and the motion parameter MV is almost the same as that of the weight W and the motion parameter MV. More specifically, the weight W₁ ranges from 0 to 1, i.e., when the pixel at the target position of the image frame moves (when the motion parameter MV is large), the weight W₁ approximates 0, and the adjusted chrominance value C′₁₃_{_{—}}₁ approximates C₁₃_{_{—}}₁; in contrast, when the image is static (when the motion parameter MV of the pixel is equal to 0 or 1), the weight W₁ approximates 1, and the adjusted chrominance value C′₁₃_{_{—}}₁ is equal to C″₁₃_{_{—}}₁, i.e., a complete cross-color compensation is performed on the pixel P₁₃.

In conclusion, the foregoing Step 312 to Step 316 merely describe an embodiment of the present invention and are not construed as limiting the present invention, i.e., provided that the chrominance adjusting unit 224 determines a weight of an initial chrominance value of a pixel at a target position of the previous field F₀_{_{—}}ₑᵥₑₙ and a weight of an initial chrominance value of the pixel at the target position of the current field F₁_{_{—}}ₑᵥₑₙ according to a luminance motion parameter Ymv of the pixel at the target pixel and an adjusted chrominance motion parameter C′mv, and at least one of the luminance motion parameter Ymv and the adjusted chrominance motion parameter C′mv is inversely associated with the weight of the initial chrominance value of the pixel at the target position of the previous field F₀_{_{—}}ₑᵥₑₙ) proper modifications made are within the scope and spirit of the present invention.

The abovementioned chrominance adjusting operation is performed on all pixels at the field F₁_{_{—}}ₑᵥₑₙ, and a plurality of chrominance-adjusted fields D_{field}′ are generated and provided to the de-interlacing unit 230.

In Step 318, the de-interlacing unit 230 performs de-interlacing on the plurality of chrominance-adjusted fields D_{field}′ to generate a plurality of frames D_{frame}. In Step 320, the image scaling unit 240 performs scaling on the plurality of frames D_{frame} to generate a display images Dₒᵤₜ to a display.

It is to be noted that, in the foregoing description of the image processing apparatus 200 in FIG. 2 to FIG. 6, the field F₀_{_{—}}ₑᵥₑₙ is a previous even field before the field F₁_{_{—}}ₑᵥₑₙ. As for a pixel at a same target position of the fields F₀_{_{—}}ₑᵥₑₙ and F₁_{_{—}}ₑᵥₑₙ an a chrominance value of the pixel at the target position of the field F₁_{_{—}}ₑᵥₑₙ is adjusted according to pixels of the fields F₀_{_{—}}ₑᵥₑₙ and F₁_{_{—}}ₑᵥₑₙ. However, in other embodiments of the present invention, the field F₀_{_{—}}ₑᵥₑₙ may be a next even field of the field F₁_{_{—}}ₑᵥₑₙ, and a chrominance value of the pixel at the target of the field F₁_{_{—}}ₑᵥₑₙ is also adjusted according to pixel of the fields F₀_{_{—}}ₑᵥₑₙ and F₁_{_{—}}ₑᵥₑₙ. A related calculation approach is the same as described in the flow of FIG. 3, i.e., the next even field of the field F₁_{_{—}}ₑᵥₑₙ is regarded as the field F₀_{_{—}}ₑᵥₑₙ. Such modifications of the embodiments are apparent to a person having ordinary skill in the art, and details thereof shall not be described for brevity.

It is to be noted that, in the embodiment shown in FIG. 3, the chrominance adjusting unit 224 generates a motion parameter MV according to a luminance motion parameter Ymv, and an adjusted chrominance motion parameter C′mv that is generated according to a chrominance motion parameter Cmv, a cross-color edge value CCEV and a real-color edge value RCEV. However, in other embodiments of the present invention, the adjusted chrominance motion parameter C′mv is generated according to the cross-color edge value CCEV (i.e., the adjusted chrominance motion parameter C′mv is calculated using Formula (8)). After that, the image adjusting unit 220 generates the motion parameter MV according to the luminance motion parameter Ymv and the adjusted chrominance motion parameter C′mv calculated using Formula (8). In addition, the image adjusting unit 220 can even generate the motion parameter MV according to the luminance motion parameter Ymv and the chrominance motion parameter Cmv, and such design modifications are also within the scope and spirit of the present invention.

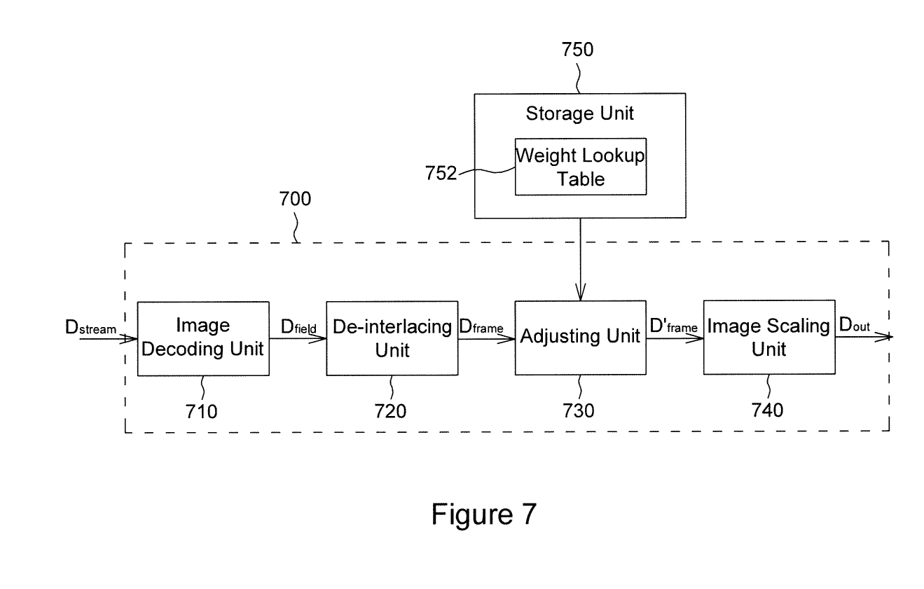

FIG. 7 shows a schematic diagram of an image processing apparatus 700 in accordance with a second embodiment of the present invention. The image processing apparatus comprises an image decoding unit 710, a de-interlacing unit 720, an image adjusting unit 730, and an image scaling unit 740, wherein the image adjusting unit 730 is coupled to a storage unit 750 comprising a weight lookup table 752. In addition, the image processing apparatus 700 is realized by hardware or software.

A difference between the image processing apparatus 700 and the image processing apparatus 200 in FIG. 2A is that the image adjusting unit 220 of the image processing apparatus 200 performs image adjusting with respect to fields, and the image adjusting unit 730 of the image processing apparatus 700 performs image adjusting with respect to frames. In addition, operations of the image adjusting unit 730 are similar to those of the image adjusting unit 220, and a person having ordinary skill in the art can easily infer an operation flow of the image processing apparatus 700 with reference to the description associated with the image processing apparatus 200, such that details thereof shall not be described for brevity.

In conclusion, an image processing apparatus provided by the present invention determines a degree of cross-color compensation according to whether an image moves, and provides conceptions of determining whether the image moves according to a luminance motion parameter, a chrominance motion parameter, a cross-color edge value and a real-color edge value, so that the image processing apparatus can accurately determine whether the image moves or varies to further perform an optimal cross-color compensation according to a degree of motion or variation of the image, thereby improving quality of the image.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. An image processing apparatus, comprising:
an image decoding unit, for decoding a data stream to generate at least a first image and a second image, the first image and the second image respectively having a first pixel and a second pixel at the same position; and
an image adjusting unit, coupled to the image decoding unit, comprising:
a luminance motion calculating module, for calculating a luminance motion parameter according to an initial luminance value of the first pixel and an initial luminance value of the second pixel;
a chrominance motion calculating module, for calculating a chrominance motion parameter according to an initial chrominance value of the first pixel and an initial chrominance value of the second pixel; and
a chrominance adjusting module, for generating an adjusted chrominance value of the first pixel according to a weighted average of the initial chrominance value of the first pixel and the initial chrominance value of the second pixel with reference to the luminance motion parameter and the chrominance motion parameter.

2. The image processing apparatus as claimed in claim 1, wherein the luminance motion calculating module calculates the luminance motion parameter further according to a plurality of initial luminance values of pixels neighboring to the first pixel and a plurality of initial luminance values of pixels neighboring to the second pixel.

3. The image processing apparatus as claimed in claim 2, wherein the chrominance motion calculating module further calculates the chrominance motion parameter according to a plurality of initial chrominance values of pixels neighboring to the first pixel and a plurality of initial chrominance values of pixels neighboring to the second pixel.

4. The image processing apparatus as claimed in claim 1, wherein the first image and the second image are fields or frames, the first image is a current image, and the second image is a previous image or a next image.

5. The image processing apparatus as claimed in claim 1, wherein the chrominance motion calculating module comprises a chrominance motion parameter adjusting module, for generating a cross-color edge value according to the initial chrominance value of the first pixel and the initial chrominance values of pixels neighboring to the first pixel; generating a real-color edge value according to the initial chrominance value of the first pixel, the initial chrominance values of pixels neighboring to the first pixel, the initial chrominance value of the second pixel, and the initial chrominance values of pixels neighboring to the second pixel; and generating an adjusted chrominance motion parameter according to the chrominance motion parameter, the cross-color edge value and the real-color edge value to replace the chrominance motion parameter.

6. The image processing apparatus as claimed in claim 5, wherein the chrominance motion parameter adjusting module generates the cross-color edge value by calculating differences between the initial chrominance value of the first pixel and the initial chrominance values of pixels neighboring to the first pixel.

7. The image processing apparatus as claimed in claim 5, wherein the chrominance motion parameter adjusting module generates the real-color edge value by weighted averaging a plurality of differences of a plurality of average chrominance values of the first pixel and pixels neighboring to the first pixel, wherein the average chrominance values are the averages of the initial chrominance values of the first pixel and the second pixel and the pixels neighboring to the first pixel and the second pixel.

8. The image processing apparatus as claimed in claim 1, wherein the chrominance adjusting module further generates a motion parameter according to the luminance motion parameter and the chrominance motion parameter, determines two weights for the first pixel and the second pixel according to the motion parameter, and generates the adjusted chrominance value of the first pixel by weighted averaging the initial chrominance values of the first pixel and the second pixel, wherein the motion parameter being positively correlated with the initial chrominance value of the first pixel.

9. An image processing apparatus, for processing a plurality of images comprising a first image and a second image, the first image and the second image respectively having a first pixel and a second pixel at the same target position, the image processing apparatus comprising:
a chrominance averaging module, for averaging two initial chrominance values of the first pixel and the second pixel to generate an average chrominance value of the first pixel;
a luminance motion parameter calculating module, for calculating a luminance motion parameter according to two initial luminance values of the first pixel and the second pixel;
a chrominance motion calculating module, for calculating a chrominance motion parameter according to the initial chrominance values of the first pixel and the second pixel; and
a chrominance adjusting module, for generating an adjusted chrominance value of the first pixel by weighted averaging the average chrominance value of the first pixel and the initial chrominance value of the first pixel according to the luminance motion parameter and the chrominance motion parameter.

10. The image processing apparatus as claimed in claim 9, wherein the luminance motion calculating module calculates the luminance motion parameter further according to a plurality of initial luminance values of pixels neighboring to the first pixel and the second pixel.

11. The image processing apparatus as claimed in claim 10, wherein the chrominance motion calculating module calculates the chrominance motion parameter further according to a plurality of initial chrominance values of pixels neighboring to the first pixel and the second pixel.

12. The image processing apparatus as claimed in claims 9, wherein the chrominance motion calculating module comprises a chrominance motion parameter adjusting module, for generating a cross-color edge value according to the initial chrominance value of the first pixel and the initial chrominance values of pixels neighboring to the first pixel; generating a real-color edge value according to the initial chrominance value of the first pixel, the initial chrominance values of pixels neighboring to the first pixel, the initial chrominance value of the second pixel, and the initial chrominance values of pixels neighboring to the second pixel; and generating an adjusted chrominance motion parameter according to the chrominance motion parameter, the cross-color edge value and the real-color edge value to replace the chrominance motion parameter.

13. An image processing method, comprising:
decoding a data stream to generate a plurality of images comprising a first image and a second image, the first image and the second image respectively having a first pixel and a second pixel at the same target position;
calculating a luminance motion parameter according to an initial luminance value of the first pixel and an initial luminance value of the second pixel;
calculating a chrominance motion parameter according to a chrominance value of the first pixel and a chrominance value of the second pixel; and
generating an adjusted chrominance value of the first pixel by weighted averaging the initial chrominance value of the first pixel and the initial chrominance value of the second pixel according to the luminance motion parameter and the chrominance motion parameter.

14. The image processing method as claimed in claim 13, wherein the step of calculating the luminance motion parameter further comprises calculating the luminance motion parameter according to a plurality of initial luminance values of pixels neighboring to the first pixel and the second pixel.

15. The image processing method as claimed in claim 14, wherein the step of calculating the chrominance motion parameter further comprises calculating the chrominance motion parameter according to a plurality of initial chrominance values of pixels neighboring to the first pixel and the second pixel.

16. The image processing method as claimed in claim 13, wherein the plurality of images are fields or frame, the first image is a current image, and the second image is a previous image or a next image.

17. The image processing method as claimed in claims 13, further comprising:
generating a cross-color edge value according to the initial chrominance value of the first pixel and the initial chrominance values of pixels neighboring to the first pixel;
generating a real-color edge value according to the initial chrominance value of the first pixel, the initial chrominance values of pixels neighboring to the first pixel, the initial chrominance value of the second pixel, and the initial chrominance values of pixels neighboring to the second pixel; and
generating an adjusted chrominance motion parameter according to the chrominance motion parameter;
wherein the chrominance motion parameter is replaced by the adjusted chrominance motion parameter.

18. The image processing method as claimed in claim 17, wherein the step of generating the cross-color edge value comprises:
calculating differences between the initial chrominance value of the first pixel and the initial chrominance values of pixels neighboring to the first pixel.

19. The image processing method as claimed in claim 17, wherein the step of generating the real-color edge value comprises:
weighted averaging a plurality of differences of a plurality average chrominance values of the first pixel and pixels neighboring to the first pixel, wherein the average chrominance values are the averages of the initial chrominance values of the first pixel and the second pixel and the pixels neighboring to the first pixel and the second pixel.
